(19) United States
(12) Patent Application Publication
(10) Pub. No.: US 2003/0057582 A1
(43) Pub. Date: Mar. 27, 2003

(54) DIAPHRAGM CHAMBER MOLDING APPARATUS AND METHOD

(76) Inventors: EDWARD BERNARDON, BEDFORD, MA (US); MARK CONDON, MELROSE, MA (US); CRAIG D. MYERS, NEWTON CENTRE, MA (US); ROBERT FAIZ, SANDY HOOK, CT (US); LAWRENCE FALLON, DANVERS, MA (US); ROBERT FLORY, CONCORD, MA (US); CHRISTOPHER MORSE, GRANBY, MA (US)

Correspondence Address: IANDIORIO AND TESKA, 260 BEAR HILL ROAD, WALTHAM, MA, 02154

(21) Appl. No.: 08/683,928

(22) Filed: Jul. 19, 1996

Related U.S. Application Data
(62) Division of application No. 08/487,858, filed on Jun. 7, 1995, now abandoned.
Application No. 08/487,858 is a continuation-in-part of application No. 08/271,561, filed on Jul. 7, 1994, now Pat. No. 5,464,337.
Application No. 08/271,561 is a continuation-in-part of application No. 07/869,384, filed on Apr. 15, 1992, now abandoned.
Application No. 07/869,384 is a continuation-in-part of application No. 07/675,819, filed on Mar. 27, 1991, now Pat. No. 5,151,277.

(51) Int. Cl. B29C 70/44; B29C 70/48

(52) U.S. Cl. 264/40.1; 264/510; 264/161; 264/313; 264/316; 264/291; 264/292; 264/258; 425/112; 425/389

(57) ABSTRACT

A diaphragm chamber molding apparatus and method including a chamber for containing a mold surface therein; a bottom flexible diaphragm placed over and sealable with respect to the top of the chamber; a top flexible diaphragm placed over and sealable with respect to the bottom diaphragm for containing a lay-up between the top and bottom diaphragms; means for evacuating the area between the top and bottom diaphragms; and means for drawing the top and bottom diaphragms and the lay-up therebetween down over a mold surface located in the chamber to form the lay-up.

### RELATED CASES

This application is a Continuation-In-Part of U.S. Ser. No. 08/271,561, filed Jul. 7, 1994, entitled “RESIN TRANSFER MOLDING SYSTEM AND METHOD” by Bernardon et al., which is a Continuation-In-Part of U.S. Ser. No. 07/869,384, filed Apr. 15, 1992, entitled “RESIN TRANSFER MOLDING SYSTEM AND METHOD” by Bernardon et al., which is a Continuation-In-Part of U.S. Ser. No. 07/675, 819 filed Mar. 27, 1991, entitled “RECONFIGURABLE FIBER-FORMING RESIN TRANSFER SYSTEM” by Bernardon et al.

### FIELD OF INVENTION

This invention relates to a diaphragm chamber molding apparatus and method, and more particularly to such an apparatus and method for forming a composite part in a sealable chamber.

### BACKGROUND OF INVENTION

Fiber reinforced composite parts are fabricated utilizing a variety of conventional techniques including resin transfer molding (RTM), “prepreg” procedures, and preforming operations. These three techniques are discussed in turn below.

RTM is a derivative of traditional injection molding except that fluid (resin) is injected into a fibrous preform instead of an empty cavity mold, RTM, however, requires labor intensive and hence costly lay-up of the sheets of dry fiber onto a mold. After the hand lay-up is completed, the mold is closed, resin is injected, and allowed to cure. Another disadvantage is that uniform impregnation of the fiber workpiece is difficult to achieve. The learning curve associated with new geometries includes the costly experimentation necessary to optimize processing variables and tool design to achieve void free uniform impregnation. Accordingly, complicated analysis and experimentation involving various configurations of the resin injection ports and vents is required to achieve uniform dispersion of resin through the fiber workpiece. Another problem with conventional RTM techniques is that resin gets caked on the tools. Therefore, the tool surfaces must be thoroughly cleaned in order to prevent surface irregularities on successively formed parts. Still, RTM has advantages. It uses the lowest cost materials possible (fiber and resin) and a high degree of geometric complexity and part integration is possible. Also, because injection pressures are relatively low, equipment costs are typically less than other methods.

“Prepreg” procedures involve hand lay-up of “prepreg” tape or fabric (fibers plus resin precombined). It provides one advantage over RTM in that the problem of uniform dispersion of the resin is diminished somewhat. But, since the “prepreg” must be cured in an autoclave and since labor intensive lay-up of the prepreg tape is still required, “prepreg” techniques still possess many of the same inherent disadvantages as RTM. Furthermore, the “prepreg” materials are expensive as compared to the raw resin and dry fiber used in RTM. Additionally, the uncured “prepreg” fiber plies have certain specified shelf life and temperature limitations which add to the overall costs of manufacture. Moreover, the autoclave itself introduces additional costs as well as temperature and pressure control problems, and means are needed to prevent separation of the plies while they cure in the autoclave. Most importantly, however, “prepreg” techniques add nothing over the RTM process to overcome the costly labor intensive lay-up of the plies of fiber material.

Preforming methods utilizing sizing or tackifiers which hold the fabric in a “preformed” shape partly eliminate the disadvantage of the expensive hand lay-up required in RTM and “prepreg” fabrication techniques. But, as with “prepreg”, there are inherent problems. Primarily, since the preform must be transferred to a conventional RTM tool for resin injection, preforming does not overcome the problem of non-uniform impregnation. Also, as with “prepreg” procedures, the raw material costs are higher than the raw fiber and resin used in RTM. Finally, in conventional preforming operations, part geometry is often limited since the difficulty of maintaining the preform material about the surface contours of the mold without undue wrinkling increases as the geometry becomes more complex.

Therefore, these methods individually do not solve all the problems of the cost effective RTM method without introducing their own shortcomings. This is also true for other techniques such as thermoplastic automated tape layering or filament winding processes, and pultrusion. Unless a given fabrication system shows an overall cost benefit to the user, it has little value as a practical innovation. Unfortunately, no known system singularly eliminates the labor intensive lay-up required by RTM and “prepreg” procedures, the problems inherent in forming complex geometries, and the problem of nonuniform impregnation in fabricating a fully impregnated and formed part.

### SUMMARY OF INVENTION: I

It is therefore an object of this invention to provide a diaphragm chamber molding apparatus and method of forming composite structures.

It is a further object of this invention to provide such a diaphragm chamber molding apparatus and method of forming which is capable of forming complex geometries.

It is a further object of this invention to provide such a diaphragm chamber molding apparatus and method of forming which achieves uniform impregnation of the fiber material without the need for complicated analysis or experimentation.

It is a further object of this invention to provide such a diaphragm chamber molding apparatus and method of forming which may be used to form “prepreg” material, as well as raw fiber and resin and also such an apparatus which can be used to make preforms.

It is a further object of this invention to provide such a diaphragm molding apparatus and method of forming in which human handling or touch labor is minimized.

It is a further object of this invention to provide such a diaphragm chamber molding apparatus and method of forming which has the ability to form a wide variety of configurations of fiber reinforced composite parts.

It is a further object of this invention to provide such a diaphragm chamber molding apparatus and method which eliminates the tendency for wrinkles to form during the forming process.

It is a further object of this invention to provide such a diaphragm chamber molding apparatus which is versatile and can result in an end product which is a cured and formed composite part or a preform which can be fully cured at a later time.

This invention results from the realization that a chamber containing a mold surface and constructed with a pair of flexible diaphragms which contain a fiber workpiece between them and which can be brought down over the mold surface achieves significant improvements over prior forming techniques and that the methodology of leaving “tails” of a prepreg tape extending from the lay-up reduces the tendency for wrinkles to form in the part during forming in such a diaphragm chamber. This invention results from the further realization that if the viscosity characteristics of the resin used are analyzed before forming, forming can then occur at the optimal viscosity of the resin used.

### SUMMARY OF INVENTION II

This invention features and may suitably comprise, include, consist essentially of and/or consist of a diaphragm chamber molding apparatus. There is a chamber for containing a mold surface therein; a bottom flexible diaphragm placed over and sealable with respect to the top of the chamber; a top flexible diaphragm placed over and sealable with respect to the bottom diaphragm for containing the lay-up between the top and bottom diaphragms. There are also means for evacuating the area between the top and bottom diaphragms and means for drawing the top and bottom diaphragms and a lay-up therebetween down over a mold surface located in the chamber to form the lay-up.

In a preferred embodiment the diaphragm chamber molding apparatus may include a source for applying heat to the diaphragm and a lay up therebetween. The chamber may include a seal around the top for engaging the bottom diaphragm and sealing the bottom diaphragm with respect to the top of the chamber. The top and bottom diaphragms may be secured in top and bottom frames. The top frame may include a pressure seal for sealing it with respect to the bottom diaphragm. The means for evacuating the area between the top and bottom diaphragms may include a vacuum pump connected to evacuate air from between the top and bottom diaphragms. The means for drawing the top and bottom diaphragms down over a mold surface located in the chamber may include a vacuum pump connected to the chamber for evacuating air from within the chamber sealed by the bottom diaphragm to draw the top and bottom diaphragms down over the mold surface. The diaphragm chamber molding apparatus of this invention may further include control and monitoring apparatus for operating the means for evacuating the air between said top and bottom diaphragms, for operating the means for drawing the top and bottom diaphragms and a lay-up therebetween down over a mold surface located in the chamber and for monitoring the status of the means for evacuating and the means for drawing.

This invention also features and may comprise, include, consist essentially of andlor consist of a method of forming a composite part. The method includes assembling a lay-up on a template and forming the lay-up in a diaphragm chamber molding apparatus including top and bottom diaphragms elastically deformable over a mold surface, placing the lay-up between the diaphragms, the diaphragms and lay-up therebetween stretched over the mold surface for forming the lay-up to correspond to the contours of the mold surface. Assembling the lay-up includes providing tails extending beyond the lay-up so that the top diaphragm grips the tails for stretching the lay-up and reducing wrinkles in the lay-up during forming.

In a preferred embodiment the method may include placing a plurality of layers of a fiber reinforced thermoset resin material on a template such that the tails increase in length in the layers proximate the template. The tails can be formed by extending either the fiber reinforced thermoset resin material or a material other than the fiber reinforced thermoset resin material beyond the template. During forming, the temperature and viscosity of the lay-up may be monitored and controlled and air may be evacuated from between the top and bottom diaphragms and from within the chamber molding apparatus. The molding surface and/or the molding chamber may be configured to accentuate the stretching of the diaphragms and consequently, the tails. This configuration may include placing forming members proximate the mold surface or placing forming members between the diaphragms. The method may include evaluating the viscosity characteristics of the material used in the lay-up prior to forming to facilitate forming during optimal conditions, achieving the minimum viscosity of the material before the lay-up is stretched over the mold surface and rolling the lay-up to reduce wrinkles in the lay-up during forming. The method may further include preparing the lay-up for removal from the mold surface after forming by either supercooling the lay-up or curing the lay-up. Supercooling may include packing the lay-up in dry ice while it is still in the diaphragm chamber molding apparatus. Finally, the method may include trimming the tails from the lay-up after it is formed and placing the lay-up in an autoclave after it is removed from the mold surface.

### BRIEF DESCRIPTION OF THE DRAWINGS

Other objects, features and advantages will occur to those skilled in the art from the following description of a preferred embodiment and the accompanying drawings, in which:

FIG. 1 is a diagrammatic view of an aircraft including a composite part formed in the diaphragm chamber molding apparatus according to the methodology of this invention;

FIG. 2 is a more detailed diagrammatic view of the composite part shown in FIG. 1;

FIG. 3 is a cost versus production volume chart for various prior art composite forming techniques;

FIG. 4 is a three-dimensional view of the chamber molding apparatus of this invention;

FIG. 5 is a more detailed side view of a portion of the diaphragm chamber molding apparatus of this invention showing how the top and bottom diaphragms are sealed with respect to each other and how the bottom diaphragm is sealed with respect to the forming chamber;

FIG. 6 is a three-dimensional view of the interior of the forming chamber of this invention showing the diaphragms and a lay-up therebetween drawn down over a mold surface;

FIG. 7 is a three-dimensional view of a dry ice dam formed around the mold surface shown in FIG. 6 for cooling a part after forming to prevent full curing;

FIG. 8 is a flow chart depicting the lay-up steps according to the methodology of this invention;

FIG. 9 is a top view of the template used to form a part showing the linearized curve and the directions of the different layers of a lay-up assembled on the template.

FIG. 10 is a top view of the template of FIG. 9 showing how the 90° orientated layers are placed;

FIG. 11 shows the orientation, order and length of the tails for each layer of a lay-up;

FIG. 12 is a top view of the template of FIG. 9 showing how the +45° orientated layers are placed;

FIG. 13 is a flow chart depicting the steps of forming a part according to the methodology of this invention after lay-up;

FIG. 14 is a graph which shows the relationship between temperature and viscosity of the resin used in the preferred embodiment of the present invention;

FIG. 15 is a front view of the roller used to reduce wrinkles in the part during forming;

FIG. 16 is a cross-sectional view of the chamber molding apparatus of this invention showing how forming members are placed with respect to the mold surface:

FIG. 17 is a top view of the diaphragm chamber molding apparatus showing the placement of a forming member; and

FIG. 18 is a flow chart depicting the steps of removing the part from the mold surface according to the methodology of this invention after forming.

### DISCLOSURE OF PREFERRED EMBODIMENT

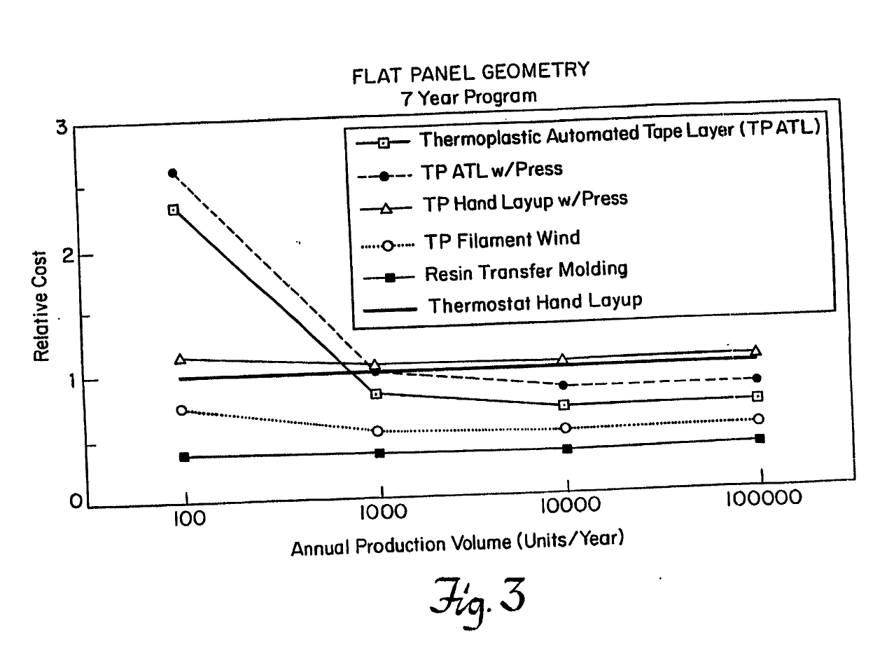

An example of the result of using the diaphragm chamber molding apparatus and the methodology of this invention is the compound curved composite C-channel shown in more detail in FIG. 2. A composite as used herein means a structure comprising a plurality of layers of fibrous fabric or tape reinforced with a resin.

As discussed in the Background of Invention, above, prior molding techniques for forming rib 10 or other composite part structures are labor intensive and costly. FIG. 3 compares relative cost per product volume for a number of prior art forming techniques. To ensure proper structural performance of the composite part in FIG. 2, it is essential that no wrinkles are formed during lay-up, forming or curing as such is often the case using hand lay-up forming techniques.

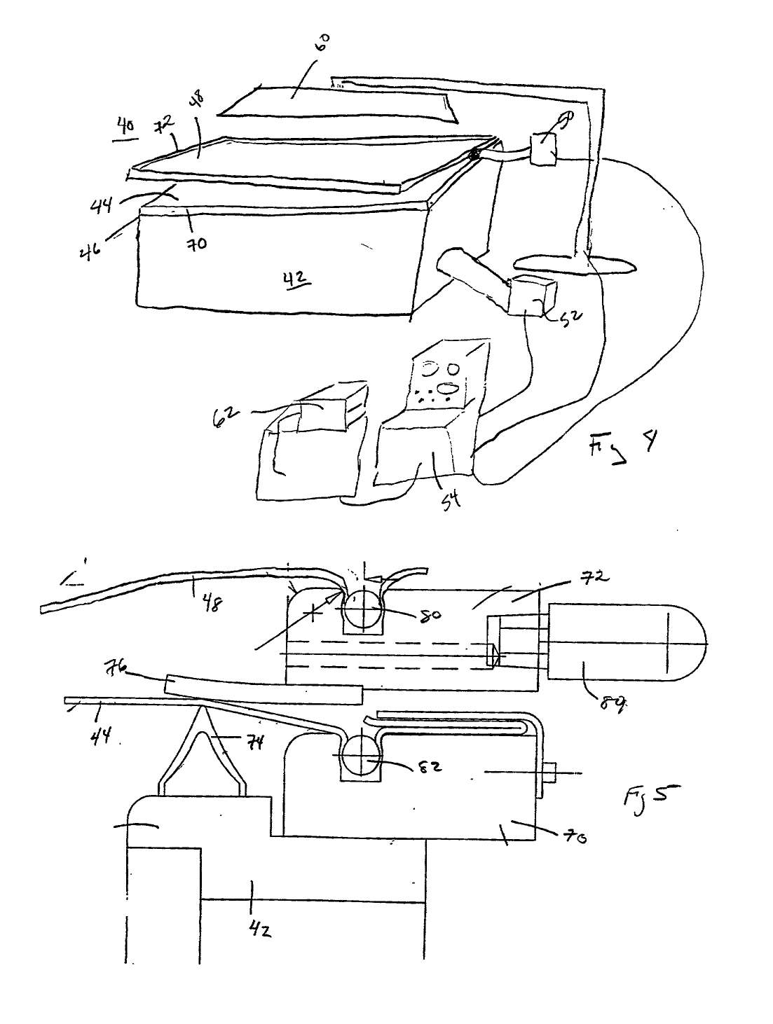

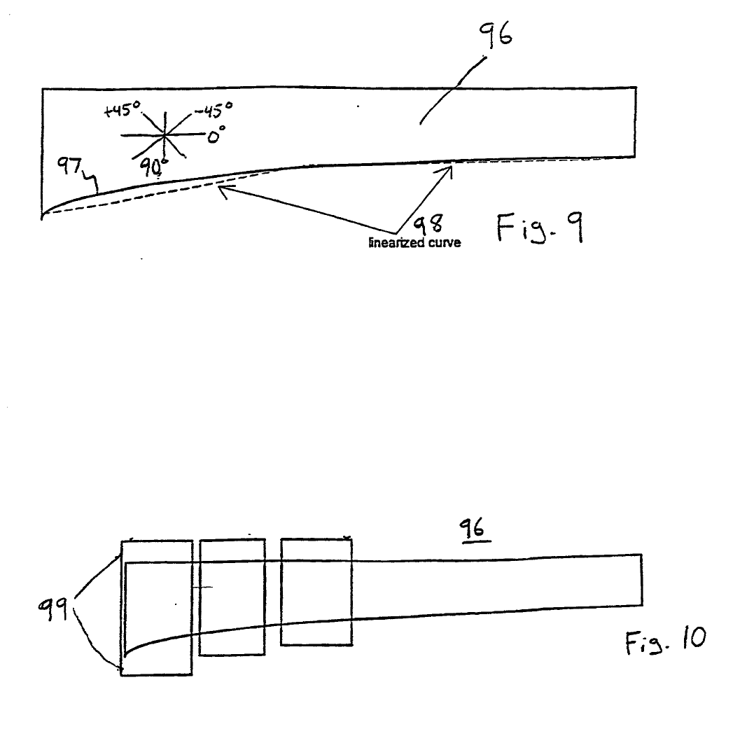

In this invention, such a part is economically formed using diaphragm chamber molding apparatus 40, FIG. 4. Apparatus 40 includes chamber 42 which contains a mold surface therein (not shown in this figure). Bottom diaphragm 44 is placed over and sealed with respect to the top 46 of chamber 42. Top diaphragm 48 (shown in a raised position in FIG. 4) is placed over and sealed with respect to bottom diaphragm 44. Vacuum pump 50 is used to evacuate the area between top 48 and bottom 44 diaphragms after a lay-up described with reference to FIGS. 8-12 is placed therebetween. Vacuum pump 52 is used to evacuate chamber 42 to draw the top 48 and bottom 44 diaphragms and a lay-up therebetween down over a mold surface located in chamber 42 to form the diaphragms and the lay-up to the contours of the mold surface without the need for labor intensive and costly hand forming procedures.

Controller 54 operates and monitors vacuum pumps 50 and 52 as well as heat source (e.g. infrared lamps) 60 which aid in forming. Printer 62 provides a readout for controller 54.

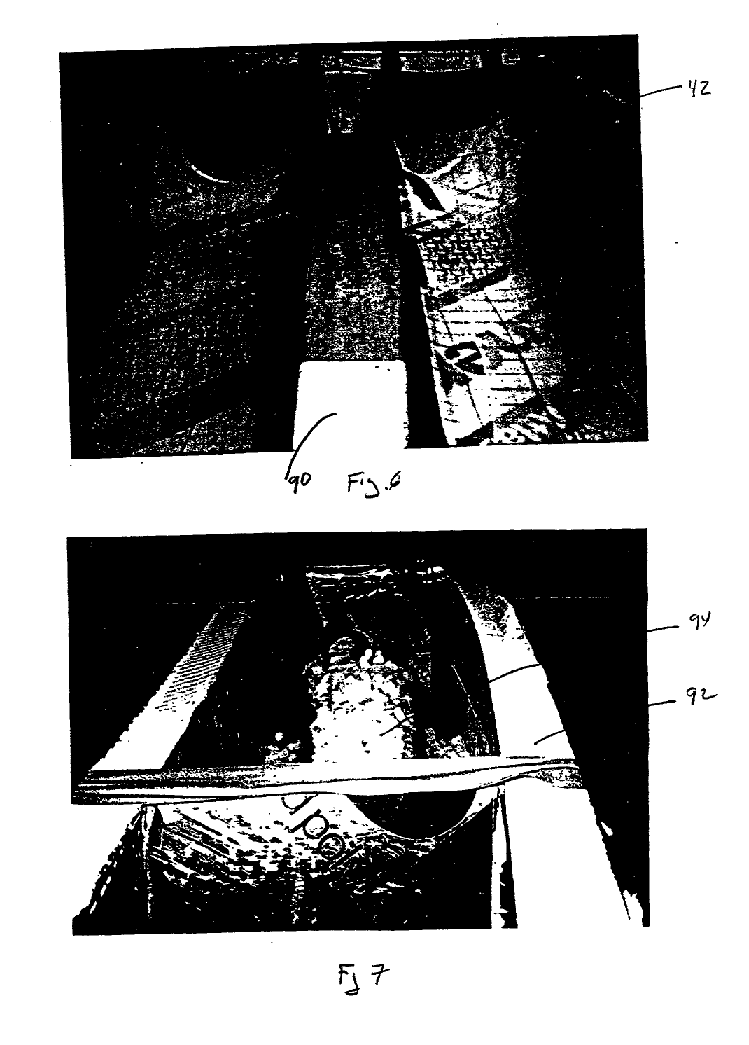

More clearly shown in FIG. 5, diaphragms 44 and 48 are secured in bottom 70 and top 72 frames, respectively. Seal 80 locks top diaphragm 48 in top frame 72; seal 82 locks bottom diaphragm 44 in bottom frame 70. Seal 74 is located on the top of chamber 42 and seals bottom diaphragm 44 with respect to chamber 42. Pressure seal 76 on the bottom of top frame 72 seals top frame 72 and therefore top diaphragm 48 with respect to bottom diaphragm 44. Coupler 89 is connected to vacuum pump 50, FIG. 4, for evacuating air from between the diaphragms.

After a lay-up is placed between the top and bottom diaphragms, air is evacuated from between the diaphragms using vacuum pump 50, FIG. 4. Vacuum pump 52 is then used to evacuate chamber 42 thereby drawing the top and bottom diaphragms and the lay-up therebetween down over a mold surface 90, FIG. 6. The part is formed without the labor intensive forming steps required of prior techniques. The diaphragms are flexible enough so that they can be drawn to the bottom of chamber 42 thereby urging the lay-up between the diaphragms to conform exactly to the mold surface 90 located within chamber 42. In a preferred embodiment, the top 48 and bottom 44 diaphragms are EL810600 cured silicon rubber 0.063″ thick available from Torr Technology of Auburn, Wash.

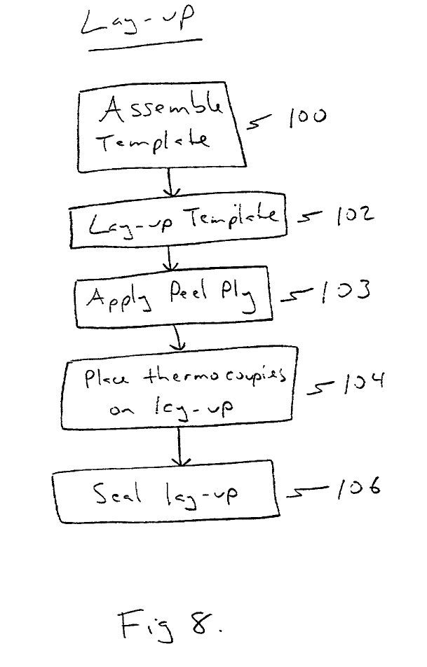

After forming, a variety of techniques can be used to cure the part or it can be left in a “preform” state by using ice dam 92, FIG. 7, containing dry ice 94 to quickly chill the part after forming. Therefore, the versatility of the molding apparatus of this invention offers an improvement over the prior art since, if the customer requires a completely formed and cured part or instead requires a “preform”, the manufacturing steps change only slightly.

The lay-up located between the top and bottom diaphragms may be dry fabric to be formed into a preform and later impregnated, layers of “prepreg” tape or fabric which are laid up and then either partially or completely cured during forming.

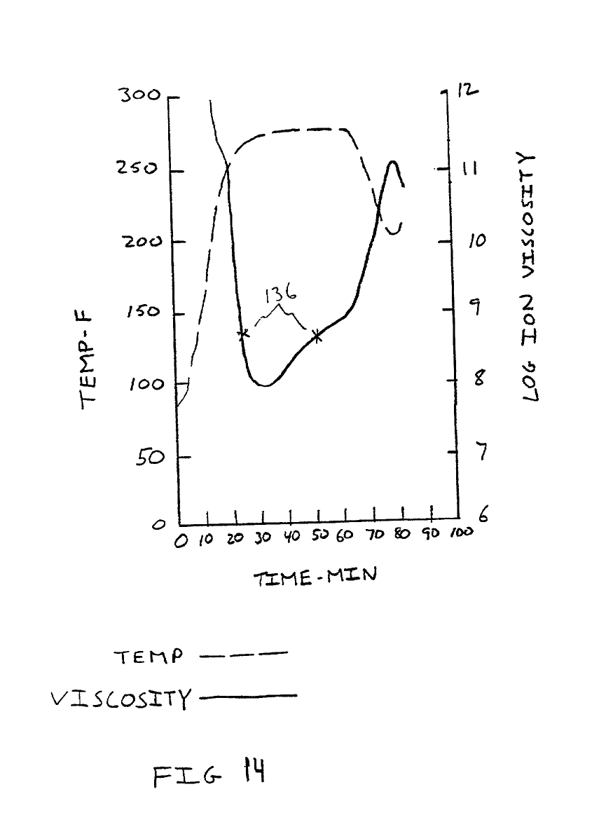

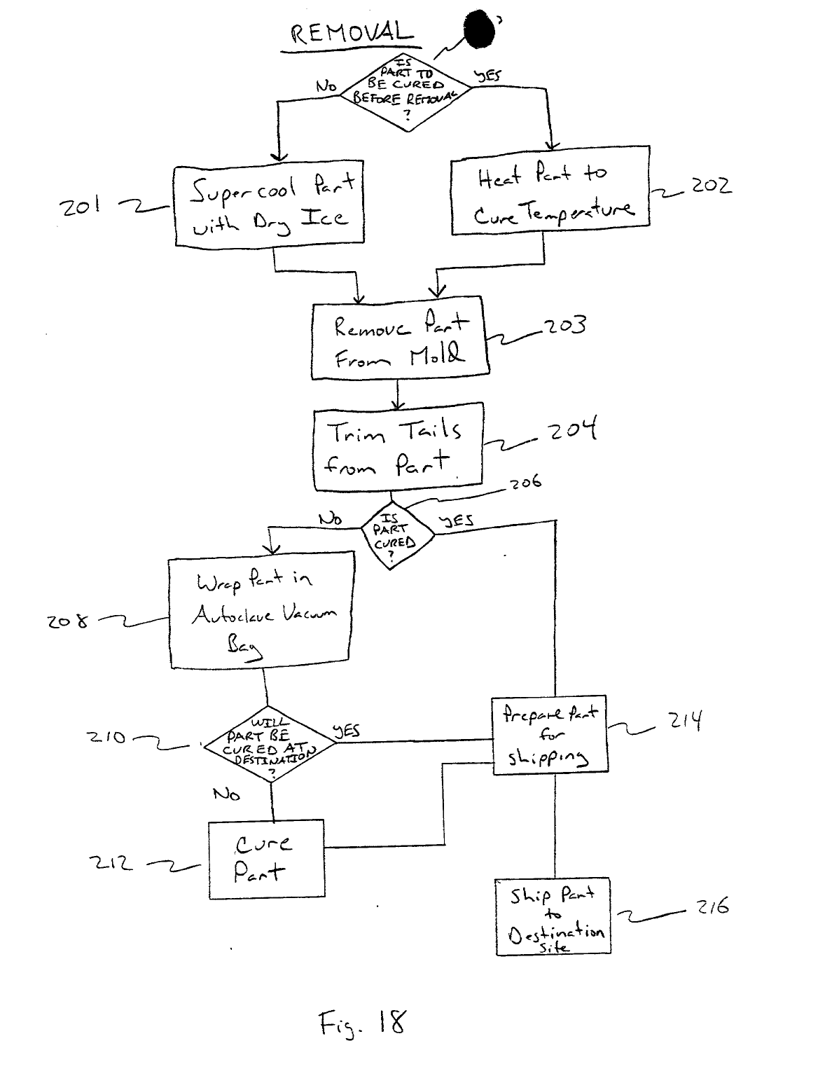

Lay-up of a “prepreg” material is discussed with reference to FIGS. 8-12; forming a laid-up “prepreg” between the diaphragms within the chamber is discussed with reference to FIGS. 13-17; and removal of a prepreg part formed in the diaphragm chamber molding apparatus of this invention is discussed with reference to FIG. 18.

Lay-Up

FIG. 8 is a flow chart which describes the lay-up process. In step 100 a template is assembled; in step 102 the lay-up is formed on the template; a peel ply is applied in step 103; in step 104, thermocouples are placed on the lay-up; and in step 106 the lay-up is sealed. These steps are discussed in more detail below.

First, a template 96 as shown in FIG. 9 is assembled to form part 10, FIG. 2. Template 96 is used as a guide for the minimum size of the lay-up. Since the curve 97 at the bottom of the template 96 may be difficult to match, a straight line approximation 98 may be used as the bottom guide.

In step 102, the lay-up is constructed of 16 balanced layers of, for example, 12″ wide graphite tape hand butted to create the lay-up. The layers are orientated in four directions: +45°, 90°, −45° and 0° relative to the longitudinal axis of the template, as shown in FIG. 9. These orientations are balanced around the center of the lay-up to reduce internal stresses in the lay-up which can cause warping.

In order to minimize wrinkling as the diaphragms are stretched over the mold, the 0° and 90° layers are extended beyond the template to form “tails” 99, FIG. 10, which increase the top diaphragm's contact area thereby enabling the diaphragm to exert increased strain on these layers. These “tails” are staggered in length to enable the top diaphragm to contact the lower layers. The tails closest to the template are the longest; the tails closest the top of the lay-up at the shortest.

To reduce cost, the tails can be formed by splicing less expensive scrap material, such as ordinary fabric, in contact with the layers in the lay-up in the same staggered-length arrangement as with the prepreg tails. Thus, when the tails are cut off of the part, the less expensive material is discarded rather than the prepreg tape itself.

FIG. 11 shows the orientation, order and length of the tails for each layer of one lay-up. The first 90° and 0° orientated layers are formed with 10″ tails, the second 90° and 0° orientated layers are formed with 8″ tails, the third 90° and 0° orientated layers are formed with 6″ tails and the fourth 90° and 0° orientated layers are formed with 4″ tails. This configuration ensures that when the top diaphragm 48, FIG. 4, is stretched over the mold, each set of tails is gripped and stretched by the diaphragm thereby minimizing wrinkles in the lay-up.

The lay-up may be constructed using prepreg such as 12″ tape from Hercules Torr. Ideally, the tape should be removed from 0° C. storage and left in its airtight container at least an hour before lay-up to allow it to come to room temperature. This prevents water condensate from forming on the graphite.

Each layer of the lay-up is started and referenced from the left side of the template. Measurements for tape length are taken from where the left side of the tape is butted to the left side of the template or the previous piece and cut square (for the 0° and 90° layers) or to 45° for the +45° or −45° degree layers with a paper cutter. Once the +45° and −45° layers are applied, the bottom edge is trimmed by hand to match the template.

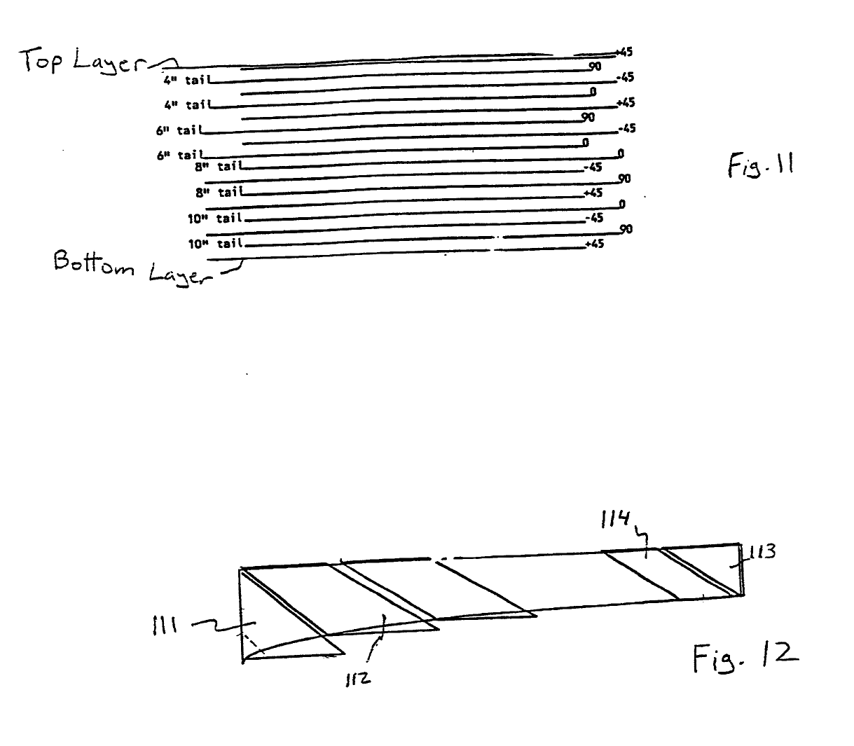

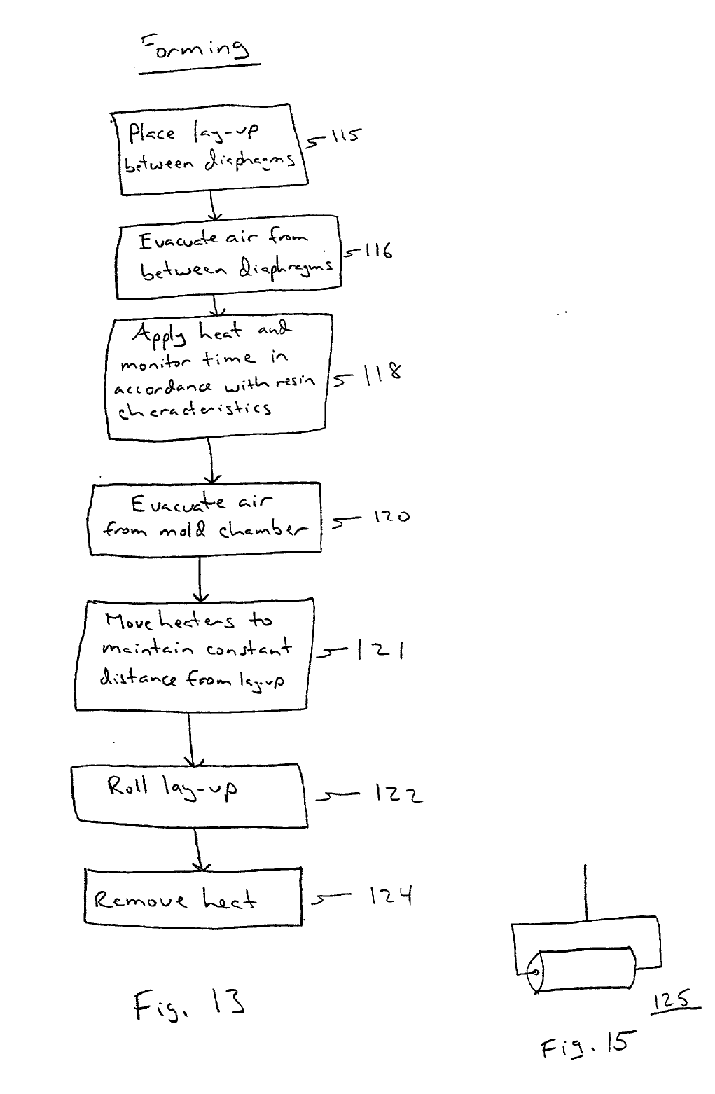

The +45° layer is the first layer which is laid out on the template. In the first layer only, the backing paper of the tape is placed against the template with the graphite facing up. FIG. 12 shows the configuration of the +45° layer. Staring at the left end of the template, a right isosceles triangle 111 is cut out of the tape with the grain running parallel to the hypotenuse. One side of the triangle is placed against the left side of the template such that the hypotenuse runs in the +45° direction as shown in FIG. 9. The triangle must be cut long enough so that the bottom side covers the entire template. The tape may not be wide enough for this, however, and there may be a small triangular void shown by the dotted line in triangle 111 at the bottom of the lay-up because the triangle will actually be a trapezoid when cut to the correct width. This can either be patched with scrap or ignored. Next, a parallelogram 112 which butts the first triangle is cut. Extreme care must be taken when cutting the parallelogram such that the grain runs in the correct direction (+45°). The bottom of the parallelogram is then trimmed to match the template. This procedure is continued along the length of the template ending with a final triangle 113. The last parallelogram 114 must be cut thinner than 12″ because the gap between the former parallelogram and final triangle will be less than 12″. In all layers, the butt joints must be as close together and parallel as possible.

The 90° orientated layer is the next layer to be laid up on the template. This and all following layers are laid with the graphite face down. This layer has 10″ tails on either side of the template, as shown by tape section 99 in FIG. 10, which means the tape must be cut 20″ longer than the width of the template at the location where the particular piece of tape will be laid. Each subsequent piece is cut to allow for 10″ tails on either side of the template as shown. Each 90° oriented piece is laid butting up against but not overlapping the preceding piece. This process is continued until the right side of the template is reached where the piece butting up against the right side of the template is trimmed accordingly.

This layer is then sealed to the previous layer using a household iron set at about 70% of maximum temperature. When sealing it is important to keep the iron in motion and use strokes that originate in the center of the template and move outward to smooth out wrinkles and work out air pockets. Once the tape is sealed down, the backing paper is removed.

The −45° layer is the third layer which is laid up on the template. This layer is placed in the same manner as the +45° layer except the initial triangle must be laid with one side on the left side of the template and the other on the top of the template with the hypotenuse running in the −45° direction. The subsequent parallelograms are cut such that the grain of the tape runs in the −45° direction. The final triangle is cut such that one side of the triangle is against the right side of the template and the other side of the triangle is against the bottom of the template and the hypotenuse is in the −45° direction. Once again with this layer and each subsequent layer, the household iron is used to seal the layer to the previous layer and once sealed, the backing paper is removed.

The 0° oriented layer is the fourth layer which is laid up on the template. This layer also has 10″ tails so it must be cut 20″ longer than the template. The most material conservative way to cut the 0° orientated layers is to use a 12″ wide piece and a 6″ wide piece. This ends up being smaller than the template but allows the use of the scrap 6″ piece in the next layer. Usually the gap is put on the top and bottom of the lay-up in alternating 0° oriented layers so as to minimize the next effect of the void.

The following table lists the order of the fifth through sixteenth layers which are laid up in the same fashion described above.

| Layer | Orientation | Tail |
|---|---|---|
| 5 | +45 | none |
| 6 | 90 | 8″ |
| 7 | −45 | None |
| 8 | 0 | 8″ |
| 9 | 0 | 6″ |
| 10 | −45 | None |
| 11 | 90 | 6″ |
| 12 | +45 | None |
| 13 | 0 | 4″ |
| 14 | −45 | None |
| 15 | 90 | 4″ |
| 16 | +45 | None |

When the lay-up is completed, the backing paper from the bottom layer is removed and a peel ply is applied to the lay-up step 103, FIG. 8. The peel ply is required to minimize undesirable surface finish that occurs, theoretically, when pin holes in the slip film (described below) allow resin to react with the diaphragm. The peel ply is placed on top of the lay-up and trimmed to the size of the template. The tails are not covered. Again, an iron is used to seal the peel ply to the graphite. The lay-up is handled gently to keep the peel ply in place to avoid wrinkles as much as possible. Two thermocouples are placed under the peel ply, step 104, at the wide end of the lay-up. One should be in the center so it will end on top of the mold and the other on the edge of the lay-up so it will be on the edge of the mold. The thermocouples are used to monitor the temperature of the lay-up during the forming steps, described below.

In step 106, lay-up is sealed in slip film. A piece long enough to cover both sides of the lay-up with several inches extra around to edges of the lay-up is cut. The lay-up is sealed in slip film so that it can move independently of the diaphragms. The slip film is sealed to itself along the edges of the lay-up using the iron. As with the peel ply, the slip film does not bond well to itself, so the lay-up must be handled carefully to avoid wrinkles.

Forming

The flow chart of FIG. 13 describes the forming process. First, the lay-up is placed between the top and bottom diaphragms (48, 44, FIG. 4) aligned so as to properly cover the mold surface during forming, step 115. In step 116, the air from the interdiaphragm region is evacuated and the outer surface of the bottom diaphragm (44, FIG. 4) is lubricated in order to allow it to slide over the mold surface more easily.

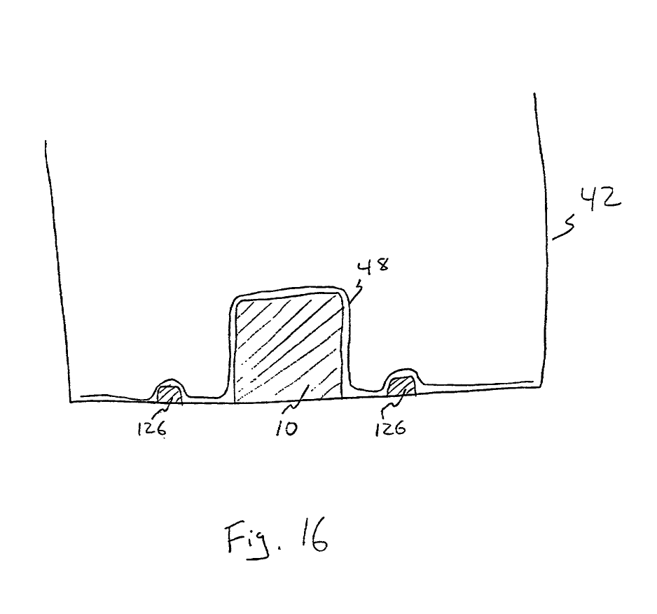

Next, in step 118, heaters (60, FIG. 4) are used to heat the lay-up to minimum viscosity before forming begins. When the resin is at its minimum viscosity, it is at its thinnest, most slippery state. Forming at minimum viscosity allows the layers to slide relative to one another and to better conform to the mold. FIG. 14 shows the relationship between the temperature and viscosity in a preferred prepreg tape used in the present invention. The critical forming constraint is a window from the beginning of heating to the beginning of resin cure. The length of this window is determined from viscosity data, which varies depending on the type of resin used. When the lay-up reaches the temperature that corresponds to the minimum viscosity of the resin, forming begins.

Referring to FIG. 14, forming begins approximately twenty minutes after heating begins when the temperature reaches its maximum at about 275° F. Even under constant temperature, the viscosity will reach a minimum value and then begin to increase with time. In this case, forming must take place within a thirty minute window (shown by X-marks 136, FIG. 14, on the viscosity graph) before the viscosity increases to the point where proper forming is no longer possible.

The evacuation of the mold chamber, step 120, FIG. 13, is done in a step-wise (quasi-equilibrium) manner in order to maintain the interdiaphragm vacuum. As forming continues and as the diaphragms are lowered onto the mold surface, the heaters must be moved, step 121, to keep a constant distance between the heaters and the lay-up to maintain uniform heating and therefore maintain minimum viscosity.

As soon as the lay-up comes into contact with the top of the mold surface, the lay-up can be rolled if wrinkling occurs, step 122. Rolling is performed to eliminate wrinkles which are not removed due to the stretching of the diaphragm. Using a large aluminum roller 125, FIG. 15, which has been preheated to 425° F. (to provide local heating instead of local cooling), the entire mold surface is rolled with as much force as possible. Special attention must be paid to the corners and curving section of the mold surface as these are wrinkle trouble spots. A smaller hand roller can be used to work on wrinkles that have been identified through the diaphragm. Very short “wiggle strokes” are used to propagate the wrinkles through the lay-up: long strokes may have a tendency to crush a wrinkle. Once forming and rolling is completed, the heat is removed from the formed part, step 124.

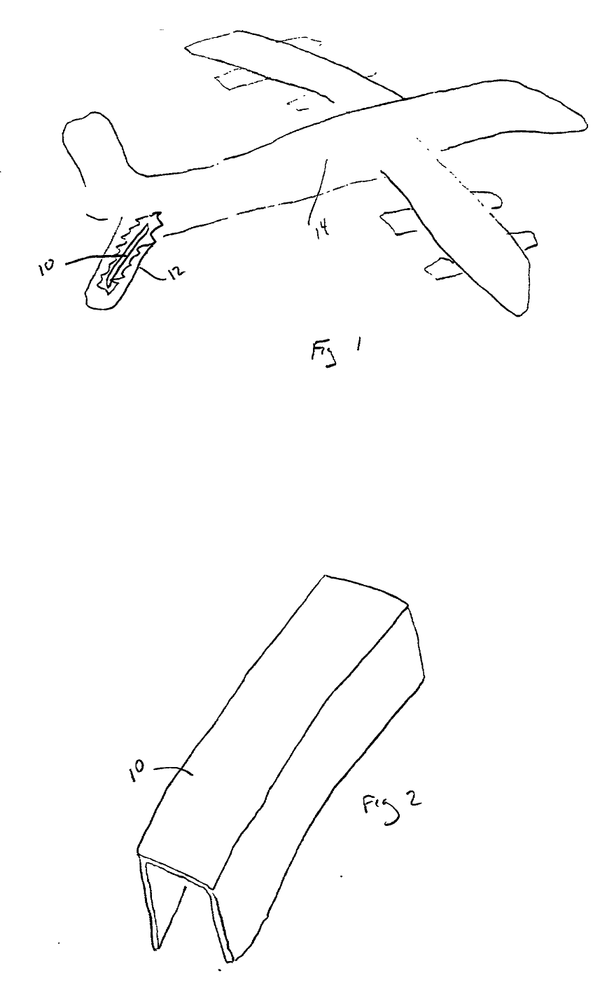

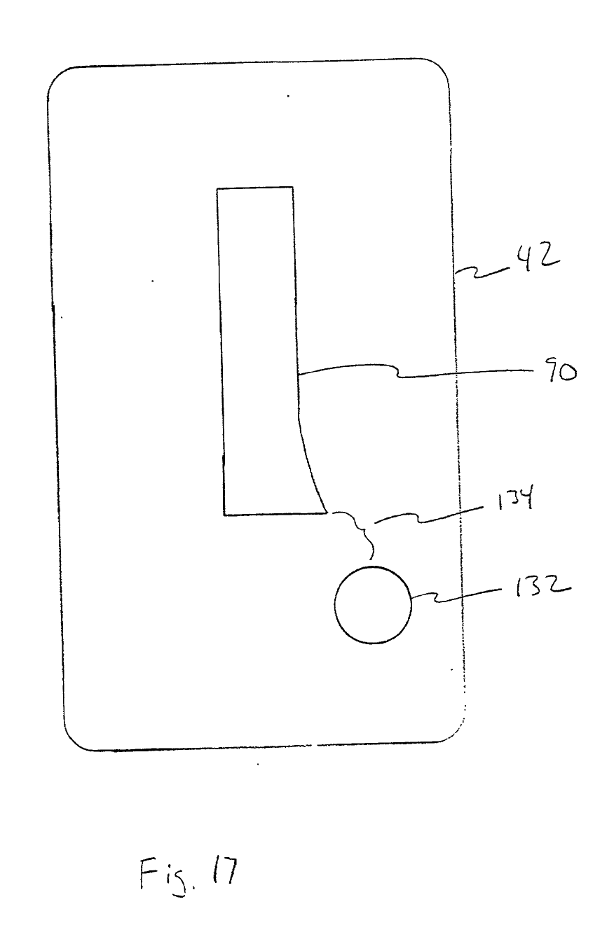

Other procedures which can be used to reduce the amount of wrinkles in the lay-up during forming are shown in FIG. 16 and FIG. 17. In FIG. 1li forming members, 126, which are approximately the same length as the mold surface, 10, are placed proximate the mold surface. The forming members increase the surface area of the chamber, which causes the top diaphragm, 48, FIG. 4. to place increased strain on the tails of the lay-up when the mold chamber, 42, is evacuated and the lay-up is pressed over the mold surface. This causes increased stretching of the tails, thus further reducing wrinkling in the lay-up. In FIG. 17, a top view of the diaphragm chamber 42 is shown in which a forming member 132 is placed inside the chamber and away from mold surface 90 in order to increase the stretching of the diaphragms specifically in known wrinkle trouble spots. By causing the diaphragm to stiffen on top of the forming member, the diaphragm exerts more strain on the lay-up in the area 134 between the lay-up and the forming member. Forming members can also be placed between the diaphragms in order to accentuate stretching.

Removal

The final phase of the process is the removal of the part from the mold. In step 200 the determination of whether the part will be cured before removal from the mold surface is made. If the part is to be removed before curing, it is supercooled in dry ice, step 201, in order to raise the viscosity of the uncured part to a near solid state so that the part can be removed. Foam dikes 92, FIG. 7, are placed around the mold in order to minimize the amount of dry ice needed to supercool the part. The part is then removed from the mold, step 203, and the tails are trimmed from the part, step 204. In step 206, because the part is not cured, it is wrapped in an autoclave vacuum bag, step 208. In step 210, if the part is to be cured at its destination site, it is then prepared for shipping, step 214. If not, the part is cured in an autoclave, step 212, before being prepared for shipping, step 214. The part is then shipped to its destination site, step 216.

If the part is to be cured before removal, step 200, the part is heated to cure temperature in order to cure the part, step 202. The part is then removed from the mold, step 203, the tails are trimmed from the part, step 204, the part is prepared for shipping, step 214, and the part is then shipped to its destination site, step 216.

Although specific features of the invention are shown in some drawings and not others, this is for convenience only as some feature may be combined with any or all of the other features in accordance with the invention.

Other embodiments will occur to those skilled in the art and are within the following claims:

What is claimed is:

1. A diaphragm chamber molding apparatus comprising:
a chamber for containing a mold surface therein;
a bottom flexible diaphragm placed over and sealable with respect to the top of said chamber;
a top flexible diaphragm placed over and sealable with respect to said bottom diaphragm for containing a lay-up between said top and bottom diaphragms;
means for evacuating the area between said top and bottom diaphragms; and
means for drawing said top and bottom diaphragms and said lay-up therebetween over a mold surface located in said chamber to form said lay-up.

2. The diaphragm chamber molding apparatus of claim 1 further including a source for applying heat to said diaphragms and said lay-up therebetween.

3. The diaphragm chamber molding apparatus of claim 1 in which said chamber includes a seal around the top thereof for engaging said bottom diaphragm and sealing said bottom diaphragm with respect to the top of said chamber.

4. The diaphragm chamber molding apparatus of claim 1 in which said top and bottom diaphragms are secured in top and bottom frames.

5. The chamber diaphragm molding apparatus of claim 4 in which said top frame includes a pressure seal for sealing said top frame with respect to said bottom diaphragm.

6. The diaphragm chamber molding apparatus of claim 1 in which said means for evacuating the area between said top and bottom diaphragms includes a vacuum pump connected to evacuate air from between said top and bottom diaphragms.

7. The diaphragm chamber molding apparatus of claim 1 in which said means for drawing said top and bottom diaphragms over a mold surface located in said chamber includes a vacuum pump connected to said chamber for evacuating air from within said chamber sealed by said bottom diaphragm to draw said top and bottom diaphragms down over said mold surface.

8. The diaphragm chamber molding apparatus of claim 1 further including control and monitoring apparatus for operating said means for evacuating the air between said top and bottom diaphragms and for operating said means for drawing said top and bottom diaphragms and a lay-up therebetween down over a mold surface located in said chamber and for monitoring the status of said means for evacuating and said means for drawing.

9. A method of forming a composite part, the method comprising:
assembling a lay-up on a template;
forming said lay-up in a diaphragm chamber molding apparatus including top and bottom diaphragms elastically deformable over a mold surface, said lay-up placed between said diaphragms, said diaphragms and said lay-up therebetween stretched over the mold surface for forming said lay-up to correspond to the contours of said mold surface;
in which assembling said lay-up includes providing tails extending beyond said template so that the top diaphragm grips said tails for stretching said lay-up and reducing wrinkles in said lay-up during forming.

10. The method of claim 9 in which said lay-up comprises a plurality of layers of a fiber reinforced thermoset resin material.

11. The method of claim 9 in which assembling said lay-up includes placing a plurality of layers of a fiber reinforced thermoset resin material on a template such that said tails increase in length in the layers proximate the template.

12. The method of claim 10 in which said tails are formed by extending said fiber reinforced thermoset resin material beyond said template.

13. The method of claim 10 in which said tails are formed from a material other than said fiber reinforced thermoset resin material.

14. The method of claim 9 further including the step of monitoring and controlling the temperature and viscosity of said lay-up dynamically during forming.

15. The method of claim 9 further including the step of evacuating air from between said top and bottom diaphragms.

16. The method of claim 9 further including the step of evacuating air from within said chamber molding apparatus.

17. The method of claim 9 further including the step of configuring said mold surface and/or said chamber to accentuate the stretching of said diaphragms.

18. The method of claim 17 in which the step of configuring includes placing forming members proximate said mold surface for increasing the stretching of said diaphragms and consequently said tails.

19. The method of claim 17 in which the step of configuring includes placing forming members between said diaphragms to accentuate the stretching of said diaphragms.

20. The method of claim 9 further including the step of evaluating the viscosity characteristics of the material used in said lay-up prior to forming to facilitate forming during optimal conditions.

21. The method of claim 20 in which forming includes the step of achieving the minimum viscosity of the material before said lay-up is stretched over said mold surface.

22. The method of claim 9 further including the step of rolling said lay-up to reduce wrinkles in said lay-up during forming.

23. The method of claim 9 further including the step of preparing said lay-up for removal from said mold surface after forming.

24. The method of claim 23 in which said step of preparing includes supercooling said lay-up.

25. The method of claim 23 in which said step of preparing includes curing said lay-up.

26. The method of claim 24 wherein supercooling includes packing said lay-up in dry ice while it is still in said diaphragm chamber molding apparatus.

27. The method of claim 9 further including the step of trimming said tails from said lay-up after it is formed.

28. The method of claim 9 further including the step of placing said lay-up in an autoclave after it is removed from the mold surface.

29. A method of forming a composite part, the method comprising:
assembling a lay-up on a template;
forming said lay-up between top and bottom diaphragms elastically deformable over a mold surface, said lay-up placed between said diaphragms, said diaphragms and said lay-up therebetween stretched over said mold surface for forming said lay-up to correspond to the contours of said mold surface;
in which assembling the lay-up includes providing tails extending beyond said template so that the top diaphragm grips said tails for stretching the lay-up and reducing wrinkles in said lay-up during forming; and
evaluating the viscosity characteristics of the material used in said lay-up to facilitate forming during optimal conditions.
